(19) United States
(12) Patent Application Publication
(10) Pub. No.: US 2017/0098186 A1
(43) Pub. Date: Apr. 6, 2017

(54) Product Management System with Supplier Risk Management

(71) Applicant: The Boeing Company, Chicago, IL (US)

(72) Inventors: Shuguang Song, Seattle, WA (US); William E. Krechel, Maryland Heights, MO (US); James L. Poblete, Lynnwood, WA (US); Brent Patrick LeBlanc, Bothell, WA (US)

(21) Appl. No.: 14/874,365

(22) Filed: Oct. 2, 2015

(51) Int. Cl. G06Q 10/08

(52) U.S. Cl. CPC G06Q 10/087; G06Q 10/0834

(57) ABSTRACT

A method and apparatus for managing manufacturing of a product. A computer system identifies a predicted parts shortage for parts based on historical parts shortage data and current parts shortage data. The computer system also identifies a group of parts for which a shortage is predicted and suppliers that supply the group of parts. Further, the computer system identifies a predicted supplier reaction time to resolve the predicted parts shortage. Still further, the computer system identifies ranked suppliers from the suppliers having a greatest predicted supplier reaction time. The computer system also manufactures the product using one or more of the ranked suppliers based on the ranked suppliers identified, thereby enabling reducing a risk of the shortage for the group of parts.

### BACKGROUND INFORMATION

1. Field

The present disclosure relates generally to an improved manufacturing system for products and, in particular, to a method and apparatus for manufacturing an aircraft. Still more particularly, the present disclosure relates to a method and apparatus for manufacturing an aircraft, taking into account risks of parts shortages from suppliers.

2. Background

Manufacturing products can be complex. For example, manufacturing an aircraft is performed using a manufacturing process that involves performing tasks to manufacture the aircraft. Manufacturing an aircraft may involve thousands of tasks.

The tasks may be defined using an installation plans. For example, installation plans may be present for installing a door, installing a flaperon, assembling a strut, or for some other structure that is used in manufacturing the aircraft.

Suppliers provide many of the parts used to manufacture the aircraft. Availability of parts when needed to perform tasks is important in completing manufacturing of an aircraft within a desired amount of time. Suppliers are often graded using metrics. These metrics include, for example, delivery and quality.

Delivery is a metric that measures whether the parts are delivered on time for use in manufacturing the aircraft. When parts are not delivered on time, a shortage of parts may exist until the parts are delivered. As a result, one or more tasks to be performed using those parts may not be completed until the parts are available.

Quality is a metric that measures the quality parts that are delivered for use. If the quality of a part does not meet a standard needed for use in manufacturing the aircraft, then the part is considered unavailable, even though the part has been delivered.

Suppliers may also be rated based on how the parts supplied by the suppliers can affect manufacturing of the aircraft when the parts are not available as needed. The unavailability of parts results in a part shortage for those parts.

For example, a supplier may be rated as a high priority supplier if the supplier is a sole-source of the parts, and an unavailability of the parts may lead to a line stoppage in manufacturing the aircraft. As another example, a supplier may be rated as a low priority supplier when the parts supplied by the supplier are readily available from other suppliers or sources.

Selecting suppliers using the ratings for suppliers provides a long-term solution in reducing parts shortages. This type of system, however, is not necessarily helpful in reducing issues caused by part shortages from existing suppliers used to manufacture an aircraft as quickly as desired.

Therefore, it would be desirable to have a method and apparatus that take into account at least some of the issues discussed above, as well as other possible issues. For example, it would be desirable to have a method and apparatus that overcome a technical problem with reducing parts shortages caused by suppliers currently supplying parts for manufacturing a product, such as an aircraft.

### SUMMARY

An embodiment of the present disclosure provides a method for managing manufacturing of a product. A computer system identifies a predicted parts shortage for parts based on historical parts shortage data and current parts shortage data. The computer system also identifies a group of parts for which a shortage is predicted and suppliers that supply the group of parts. Further, the computer system identifies a predicted supplier reaction time to resolve the predicted parts shortage. Still further, the computer system identifies ranked suppliers from the suppliers having a greatest predicted supplier reaction time. The computer system also manufactures the product using one or more of the ranked suppliers based on the ranked suppliers identified, thereby enabling reducing a risk of the shortage for the group of parts.

Another embodiment of the present disclosure provides another method for managing manufacturing of a product. A computer system identifies a predicted parts shortage for parts based on historical parts shortage data and current parts shortage data. The computer system also identifies a group of parts for which a shortage is predicted, suppliers that supply the group of parts, and a manufacturing process for the product that uses the group of parts. Further, the computer system identifies a correlation between tasks performed for installation plans in the manufacturing process based on historical manufacturing data for the manufacturing process. Still further, the computer system identifies an effect of a delay in the tasks caused by the predicted parts shortage for the group of parts based on the correlation between the tasks. Still yet further, the computer system identifies a predicted supplier reaction time to resolve the predicted parts shortage. The computer system also identifies ranked suppliers from the suppliers having a greatest predicted supplier reaction time. Further, the computer system manufactures the product using one or more of the ranked suppliers based on the ranked suppliers and the correlation between the tasks, enabling reducing a risk of the shortage for the group of parts.

Still another embodiment of the present disclosure provides a product management system comprising a part manager that identifies a predicted parts shortage for parts for a product based on historical parts shortage data and current parts shortage data. The part manager also identifies a group of parts for which a shortage is predicted and a group of suppliers that supply the group of parts. Further, the part manager identifies a predicted supplier reaction time to resolve the predicted parts shortage. Still further, the part manager identifies ranked suppliers from the group of suppliers having a greatest predicted supplier reaction time. Yet further still, the part manager controls manufacturing of the product based on the ranked suppliers, enabling reducing a risk of a shortage for the group of parts.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a manufacturing environment in accordance with an illustrative embodiment;

FIG. 2 is an illustration of a block diagram of a part manager in accordance with an illustrative embodiment;

FIG. 3 is an illustration of a block diagram of dataflow used to identify a predicted parts shortage in accordance with an illustrative embodiment;

FIG. 4 is an illustration of a block diagram of dataflow used to correlate tasks in accordance with an illustrative embodiment;

FIG. 5 is an illustration of a block diagram of dataflow to generate metrics in accordance with an illustrative embodiment;

FIG. 6 is an illustration of a block diagram of dataflow used to manage parts in accordance with an illustrative embodiment;

FIG. 7 is an illustration of a flowchart of a process for manufacturing a product in accordance with an illustrative embodiment;

FIG. 8 is an illustration of a flowchart of a process for managing manufacturing of a product in accordance with an illustrative embodiment;

FIG. 9 is an illustration of a block diagram of a data processing system in accordance with an illustrative embodiment;

FIG. 10 is an illustration of a block diagram of an aircraft manufacturing and service method in accordance with an illustrative embodiment;

FIG. 11 is an illustration of a block diagram of an aircraft in which an illustrative embodiment may be implemented; and

FIG. 12 is an illustration of a block diagram of a product management system in accordance with an illustrative embodiment.

### DETAILED DESCRIPTION

The illustrative embodiments recognize and take into account one or more different considerations. For example, the illustrative embodiments recognize and take into account that the current metrics and rating systems for suppliers do not provide information in a manner needed to reduce part shortages as quickly as desired with currently used suppliers.

The illustrative embodiments recognize and take into account that currently used mechanisms for obtaining information about shortages do not take in account dependencies between suppliers and non-suppliers. For example, the illustrative examples recognize and take in account that a first supplier may rely on a second supplier for components that go into the parts supplied by the first supplier. Further, the illustrative embodiments also recognize and take into account that currently correlations between tasks performed in the manufacturing process also are not taken into account.

Thus, the illustrative embodiments provide a method and apparatus for managing manufacturing of a product. A method in an illustrative example is used to manage manufacturing of the product in which a computer system identifies a predicted parts shortage for parts based on historical parts shortage data and current parts shortage data.

A group of the parts for which a shortage is predicted, suppliers that supply the group of the parts, and a manufacturing process for the product that uses the group of the parts are identified. As used herein, a “group of” when used with reference to items means one or more items. For example, a group of parts this one or more parts.

The computer system also identifies a predicted supplier reaction time to resolve the predicted parts shortage. Ranked suppliers are identified from the suppliers having a greatest predicted supplier reaction time. The product is manufactured using one or more of the ranked suppliers, based on the ranked suppliers identified, thereby enabling a reduction for a risk of a shortage for the group of the parts.

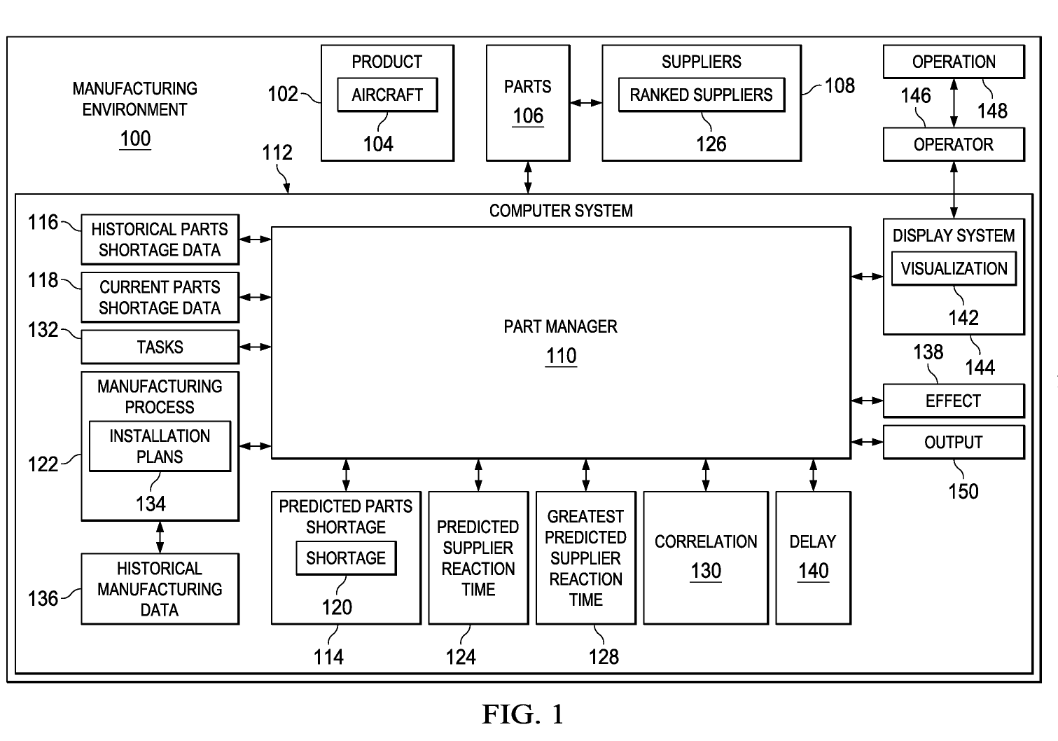

With reference now to the figures and, in particular, with reference to FIG. 1, an illustration of a block diagram of a manufacturing environment is depicted in accordance with an illustrative embodiment. As depicted, manufacturing environment 100 is used to manufacture product 102. As depicted, product 102 is aircraft 104.

In the illustrative example, product 102 is manufactured using parts 106. Parts 106 are any objects that may be installed or combined with other objects to form product 102. A part in parts 106 may be a single component and form an assembly of components.

When product 102 is aircraft 104, parts 106 may be selected at least one of a fuselage section, a wing box, a wing, a flaperon, a vertical stabilizer, a landing gear assembly, a strut, an engine, a fairing, a door, a wiring harness, a switch, an inflight entertainment system, an environmental system, a seat, a bolt, a fastener, a global positioning system receiver, a temperature sensor, a tube, a pipe, a fuel flow sensor, a bracket, or some other suitable type of part. As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

As depicted, parts 106 are obtained from suppliers 108. Part manager 110 manages manufacturing of product 102 using parts 106. Part manager 110 manages parts 106 used to manufacture product 102 as part of managing the manufacturing of product 102.

Part manager 110 may be implemented in software, hardware, firmware, or a combination thereof. When software is used, the operations performed by part manager 110 may be implemented in program code configured to run on hardware, such as a processor unit. When firmware is used, the operations performed by part manager 110 may be implemented in program code and data and stored in persistent memory to run on a processor unit. When hardware is employed, the hardware may include circuits that operate to perform the operations in part manager 110.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time, or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components, and may be comprised entirely of organic components, excluding a human being. For example, the processes may be implemented as circuits in organic semiconductors.

In the illustrative example, part manager 110 may be a module that is executed or implemented in computer system 112. As depicted, computer system 112 is a hardware system and includes one or more data processing systems. When more than one data processing system is present, those data processing systems are in communication with each other using a communications medium. The communications medium may be a network. The data processing systems may be selected from at least one of a computer, a server computer, a tablet, a mobile phone, or some other suitable data processing system.

In managing parts 106, part manager 110 in computer system 112 identifies predicted parts shortage 114 for parts 106 based on historical parts shortage data 116 and current parts shortage data 118. As depicted, historical parts shortage 116 includes data about shortages of parts 106 for product 102 over a period of the time. For example, historical parts shortage 116 may include identifications of parts shortages over months, years, or some other period of time. These parts shortages in historical parts shortage 116 may be for producing the same type or similar type of product 102. The parts shortages may be for a particular location in manufacturing environment 100 or for all locations that may be present in manufacturing environment 100 using parts 106.

Current parts shortage data 118 specifies which ones of parts 106 are currently unavailable for use in manufacturing product 102. Current parts shortage data 118 may be identified on a weekly basis, a daily basis, an hourly basis, or some other period of time that provides information about which ones of parts 106 are unavailable for manufacturing product 102.

Part manager 110 also identifies a group of parts 106 for which shortage 120 is predicted in predicted parts shortage 114, and suppliers 108 that supply the group of parts 106. In this example, the group of parts 106 is used in manufacturing process 122 to manufacture product 102.

Part manager 110 also identifies predicted supplier reaction time 124 to resolve predicted parts shortage 114. Additionally, part manager 110 identifies ranked suppliers 126 from suppliers 108 having greatest predicted supplier reaction time 128. Part manager 110, executed by computer system 112, determines predicted supplier reaction time, an identification of how long each of suppliers 108 takes to resolve a parts shortage, and includes the predicted supplier reaction time in metrics used to generate an output of ranked suppliers 126, which may be in the form of a list of suppliers 108 in an order based on predicted supplier reaction time.

Part manager 110 may control manufacturing product 102 using a group of ranked suppliers 126 based on the ranked suppliers 126 identified, thereby enabling a reduction of risk of a shortage for the group of parts 106. For example, part manager 110 may initiate production of group of parts 106 by the group of ranked suppliers 126 at a time that reduces a risk of shortage 120 for group of parts 106. In another example, part manager 110 may identifying a group of new suppliers for the group of parts 106.

In still another illustrative example, part manager 110 may provide assistance to the group of ranked suppliers 126 to reduce predicted supplier reaction time 124. For example, part manager 110 may schedule technical advisors to meet with a supplier in ranked suppliers 126. The technical advisors may aid in identifying and resolving issues to reduce predicted supplier reaction time 124 for the supplier, increase quality, reduce delays in producing parts, or some combination thereof.

In addition, part manager 110 also may identify correlation 130 between tasks 132 performed for installation plans 134 for manufacturing process 122 based on historical manufacturing data 136 for manufacturing process 122. An installation plan in installation plans 134 is a list of parts and steps performed using the parts. The task for the installation plan is the performance of the steps using the parts.

In the illustrative example, part manager 110 identifies effect 138 of delay 140 in tasks 132 caused by predicted parts shortage 114 for the group of parts 106, based on correlation 130 identified between tasks 132. Effect 138 may be, for example, selected from at least one of an impact on manufacturing jobs, impact on suppliers 108, a delay in manufacturing product 102, an impact on delivery of product 102 to a customer, or some other effect.

Visualization 142 may be displayed on display system 144 for computer system 112. Visualization 142 provides a view of information, such as rank suppliers 126, predicted supplier reaction time 124, and other suitable information that can be seen by operator 146. Visualization 142 may be used by operator 146 to perform operation 148.

As depicted, display system 144 is a physical hardware system that includes one or more display devices on which visualization 142 may be displayed. The display devices may include at least one of a light emitting diode display (LED), a liquid crystal display (LCD), an organic light emitting diode display (OLED), or some other suitable device on which visualization 142 can be displayed. Operator 146 is a person that may interact with visualization 142 when visualization 142 is part of a user interface through user input generated by an input device in computer system 112. The input device may be, for example, a mouse, a keyboard, a trackball, a touchscreen, a stylus, a motion sensing input device, a cyber-glove, or some other suitable type of input device.

Operation 148 may take different forms. For example, operation 148 is selected from a group of operations comprising initiating part production by supplier, selecting a new supplier, scheduling tasks, revising installation plans, assisting a supplier to reduce supplier reduction reaction time, and other suitable operations that may help meet desired goals in manufacturing a product.

Further, part manager 110 may generate output 150 used to initiate production of the group of parts 106 by a group of ranked suppliers 126, based on ranked suppliers 126 with greatest predicted supplier reaction time 128. In the illustrative example, output 150 may be displayed in visualization 142. For example, part manager 110 may generate an output of ranked suppliers 126 displayed in visualization 142, in the form of a list of suppliers 108 in an order based on predicted supplier reaction time 124, which is used to initiate production of the group of parts 106 by one or more ranked suppliers 126 based on predicted supplier reaction time 124. The initiation of production may also occur through outputting order 600. As depicted, part manager 110 may generate an output of order 600 in the form of a production order that may be electronically sent to one or more of ranked suppliers 126 to initiate production of the group of parts by one or more of ranked suppliers 126.

In one illustrative example, one or more technical solutions are present that overcome a technical problem with reducing parts shortages caused by suppliers 108 currently supplying parts 106 for manufacturing product 102, such as aircraft 104. As a result, one or more technical solutions may provide a technical effect, increasing the speed at which product 102 may be manufactured. In this manner, delays, such as those in at least one of manufacturing product 102 or delivering product 102 to a customer, may be reduced using part manager 110.

As a result, computer system 112 operates as a special purpose computer system, in which component part manager 110 in computer system 112 enables manufacturing product 102 with a reduced risk of shortage for a group of parts 106 used to manufacture product 102. In particular, part manager 110 transforms computer system 112 into a special purpose computer system, as compared to currently available general computer systems that do not have part manager 110.

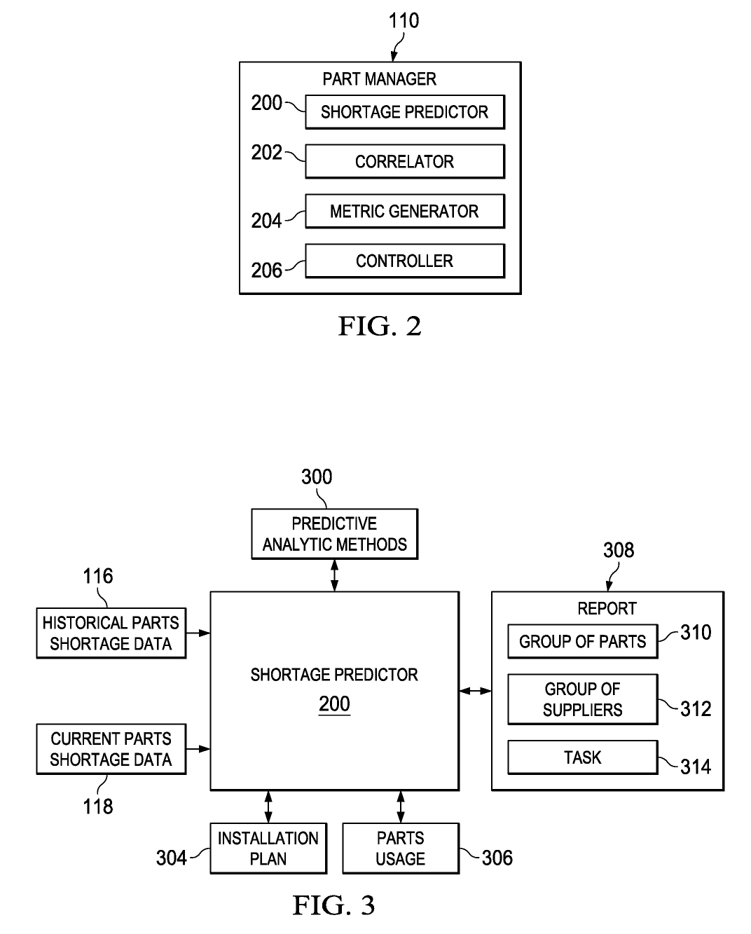

Turning next to FIG. 2, an illustration of a block diagram of a part manager is depicted in accordance with an illustrative embodiment. In the illustrative examples, the same reference numeral may be used in more than one figure. This reuse of a reference numeral in different figures represents the same element in the different figures.

An example implementation for part manager 110 is shown in this figure. As depicted, part manager 110 includes shortage predictor 200, correlator 202, metric generator 204, and controller 206.

In this illustrative example, shortage predictor 200 may be a module executed by the computer system that identifies predicted parts shortage 114 from historical parts shortage data 116 and current parts shortage data 118. Correlator 202 may be a module executed by the computer system that identifies correlation 130 between tasks 132. Metric generator 204 may be a module executed by the computer system that identifies ranked suppliers 126 from predicted supplier reaction time 124. Metric generator 204 also may identify other metrics in addition to predicted supplier reaction time 124.

In this illustrative example, controller 206 ranks suppliers 108 based on predicted supplier reaction time 124 to identify the one or more of ranked suppliers 126 having greatest predicted supplier reaction time 128. Additionally, controller 206 generates visualization 142 for display on display system 144. Controller 206 also may control manufacturing of product 102 and generate output 154 that is used to initiate production of a group of parts 106 by one or more of ranked suppliers 126. Controller 206 also may control the supply of parts from suppliers 108.

With reference now to FIG. 3, an illustration of a block diagram of dataflow used to identify a predicted parts shortage is depicted in accordance with an illustrative embodiment. In this illustrative example, shortage predictor 200 in part manager 110 in FIG. 2 receives current parts shortage data 118 and historical parts shortage data 116 as inputs.

Shortage predictor 200 identifies predicted parts shortage 114 using historical parts shortage data 116. In identifying predicted parts shortage 114, shortage predictor 200 applies a group of predictive analytic methods 300 to historical parts shortage data 116.

Predictive analytic methods 300 include statistical techniques that are employed to analyze historical data. The statistical techniques are used in generating predictions of shortage 120 of a group of parts 106 from the historical data, such as historical parts shortage data 116.

Predictive analytic methods 300 may include statistical techniques from areas selected from at least one of modeling, machine learning, data mining, and other areas. In this illustrative example, group of predictive analytic methods 300 may be used to predict trends and behavior patterns with respect to identifying predicted parts shortage 114 for parts 106.

As depicted, predicted parts shortage 114 may be predicted for shortage 120 of a group of parts 106 that occurs at some future point in time. For example, predicted parts shortage 114 may be predicted for the parts 106 recurring in the next x days. As an example, predicted parts shortage 114 may predict shortage 120 for parts 106 occurring in five days, two days, ten days, or some other period of time in the future. In yet another example, shortage 120 may be one that occurs for installations that are to be performed in the current day. In this manner, a real time identification of shortage 120 may be identified for the current day prior to installation of the group of parts 106 for which shortage 120 is present.

Shortage predictor 200 may identify predicted parts shortage 114 at different levels of granularity. For example, shortage predictor 200 selects installation plan 304 from installation plans 134 in FIG. 1. Parts usage 306 is identified from installation plan 304. As depicted, parts usage 306 identifies parts 106 in FIG. 1 that are used in installation plan 304. In another illustrative example, parts usage 306 may be of parts 106 that are for multiple ones or all of installation plans 134.

With the identification of parts usage 306, shortage 120 for the group of parts 106 used by installation plan 304 is identified. In this illustrative example, shortage predictor 200 outputs report 308. Report 308 includes group of parts 310, group of suppliers 312, and task 314. Group of parts 310 identifies one or more parts that are not available for installation plan 304. Group of suppliers 312 identifies one or more suppliers of group of parts 310. Task 314 is the task performed using installation plan 304.

As depicted, report 308 may be used to perform further analysis, identify operations to be performed, or other suitable actions. For example, rescheduling of task 314 may be made based on the predicted parts shortage for group of parts 310.

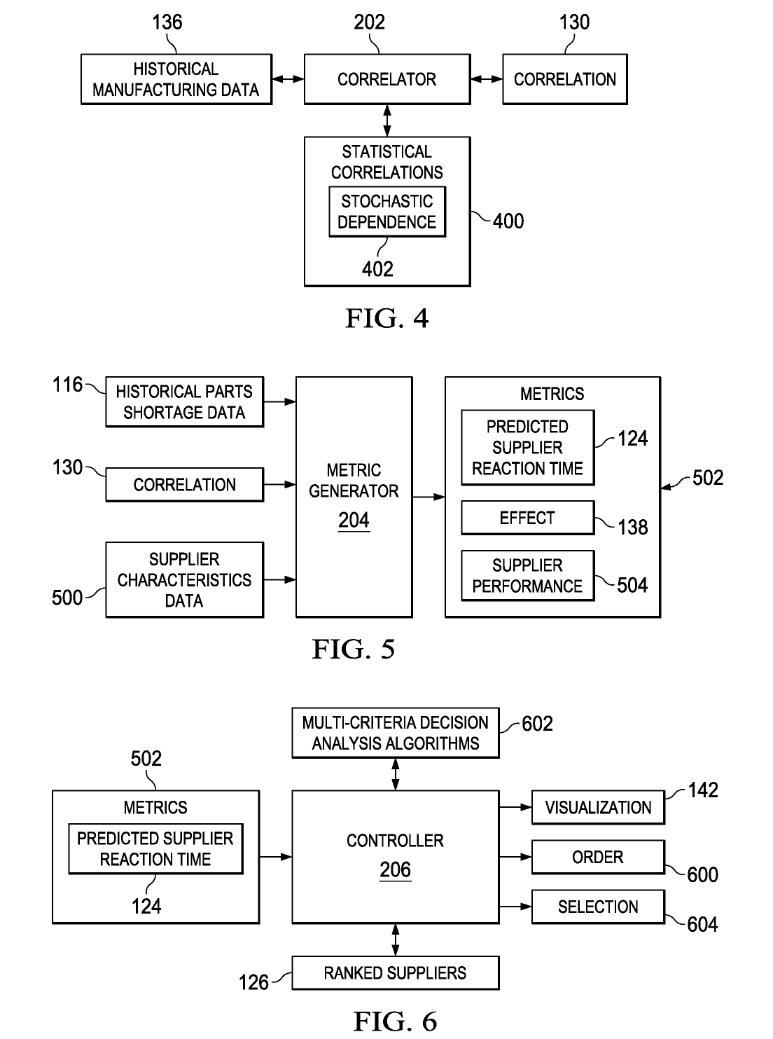

With reference next to FIG. 4, an illustration of a block diagram of dataflow used to correlate tasks is depicted in accordance with an illustrative embodiment. In this illustrative example, correlator 202 in part manager 110 in FIG. 2 identifies correlation 130 between tasks 132 in manufacturing process 122.

As depicted, historical manufacturing data 136 is input into correlator 202. In identifying correlation 130 between tasks 132, correlator 202 identifies statistical correlations 400 between tasks 132 in the illustrative example. Statistical correlations 400 between tasks 132 are identified using historical manufacturing data 136. As depicted, historical manufacturing data 136 may include historical information for manufacturing process 122, historical information about a manufacturing process similar to manufacturing process 122, and other suitable types of information.

In this illustrative example, statistical correlations 400 may identify stochastic dependence 402 between tasks 132 that are part of manufacturing process 122. Statistical correlations 400 may be identified from historical manufacturing information 136 using known techniques for measuring stochastic dependence 402. For example, without limitation, statistical correlations 400 may be identified using global measures of dependence, local measures of dependence, other measures of dependence, or various measures of dependence in combination. Examples of global measures of dependence that may be used to identify statistical correlations 208 include Pearson's rho, Kendall's tau, Spearman's rho, or other suitable measures of dependence.

Based on these identifications, correlator 202 outputs correlation 130. Correlation 130 includes statistical correlations 400 for tasks 132. In this illustrative example, tasks 132 are all tasks in manufacturing process 122 in FIG. 1.

Turning next to FIG. 5, an illustration of a block diagram of dataflow to generate metrics is depicted in accordance with an illustrative embodiment. As depicted, metric generator 204 in part manager 110 in FIG. 2 receives correlation 130 from correlator 202, historical parts shortage data 116, and supplier characteristics data 500 as inputs.

These inputs are used by metric generator 204 to generate metrics 502 as an output. Metrics 502 includes effect 138, supplier performance 504, and predicted supplier reaction time 124.

In this illustrative example, effect 138 is identified by metric generator 204 from correlation 130. As described above, effect 138 that is identified may be selected from at least one of an impact on manufacturing jobs, impact on suppliers 108, a delay in manufacturing product 102, an impact on delivery of product 102 to a customer, or some other effect.

Metric generator 204 identifies supplier performance 504 from supplier characteristics data 500. Supplier performance 504 is a historical identification of performance by suppliers 108. Supplier characteristics data 500 may include, for example, quality, on-time delivery, financial status, capacities, and other suitable information about the supplier.

In this illustrative example, predicted supplier reaction time 124 is an identification of how long each of suppliers 108 takes to resolve a shortage when one occurs. For example, predictive supplier reaction time 124 for a supplier in suppliers 108 may indicate how long the supplier takes to deliver parts when the shortage in parts 106 is caused by that supplier. The shortage may be based on at least one of late delivery or unacceptable quality of parts 106 supplied by the supplier. For example, the resolution of the shortage may be when the supplier delivers parts that can be used in manufacturing product 102.

As depicted, predicted supplier reaction time 124 is identified by metric generator 204 using historical parts shortage data 116 and supplier characteristics data 500. This identification may be made using techniques for ordered events with covariates. As depicted, techniques for ordered events with covariates may be used to identify predicted supplier reaction time 124 to resolve parts shortages. These techniques consider ordered events of an item. The ordered events may be, for example, release production order, ship items from supplier, deliver items to the manufacturer, identify part shortage, resolve parts shortage, or other suitable events.

The techniques may use statistical models for ordered events, or delay time, with or without location parameter, to predict part shortage and recovery time of part shortage in identifying predicted supplier reaction time 124. For example, a technique that considers ordered events with covariates that may be used is a regression model.

Turning to FIG. 6, an illustration of a block diagram of dataflow used to manage parts is depicted in accordance with an illustrative embodiment. In this example, controller 206 in part manager 110 in FIG. 2 uses metrics 502 to manage production of product 102 using parts 106.

For example, controller 206 may schedule tasks 132 in manufacturing process 122. The scheduling may include at least one of creating schedules or modifying schedules for tasks 132.

In another example, controller 206 may initiate production of the group of parts 106 at an earlier time that reduces a risk of shortage of the group of parts 106. The initiation of production may occur by placing an order for the group of parts 106. The initiation of production may occur through outputting order 600. As depicted, order 600 may be sent to the supplier or may be sent to operator 146 for approval or other uses. Part manager 110 may generate an output of order 600 in the form a production order for the group of parts 106 at an earlier time that reduces a risk of parts shortage, where order 600 may be electronically sent to a particular ranked supplier at a predicted lead time in advance of tasks 132 scheduled in manufacturing process 122 that requires the group of parts 106. The predicted lead time for the order electronically sent to the particular ranked supplier may be determined based on the predicted supplier reaction time for the particular ranked supplier. In this manner, part manager 110 may output an order to initiate production of the group of parts 106 at an earlier time by one or more of ranked suppliers 126 to thereby reduce a risk of shortage of the group of parts 106.

As another example, controller 206 generates and outputs visualization 142 of ranked suppliers 126. In this illustrative example, ranked suppliers 126 is a list of suppliers 108 placed in order based on predicted supplier reaction time 124.

In this illustrative example, controller 206 uses predicted supplier reaction time 124 in metrics 502 to generate ranked suppliers 126. The manner in which the ranking is identified occurs using multi-criterion decision analysis algorithms 602. The decision factors to rank suppliers 108 using multi-criterion decision analysis algorithms 602 may be categorized into numeric and subjective decision factors. Experts may provide subjective weight to each decision factor in order to rank suppliers 108. In this illustrative example, risk of not manufacturing a part on time or with a desired quality by a supplier depends on many decision factors.

Inputs into multi-criterion decision analysis algorithms 602 include, for example, at least one of on-time purchase order release, number of known downstream customers, number of rejections of parts, on-time delivery, risk assessment of suppliers, impact of supplier on manufacturing status, or other suitable metrics. Some examples of multi-criterion decision analysis algorithms 602 that may be used include, for example, Elimination and Choice Expressing Reality (ELECTRE), probability scoring, or other suitable techniques.

In this depicted example, ranked suppliers 126 are suppliers 108 having greatest predicted supplier reaction time 128. Also, greatest predicted supplier reaction time 128 may be selected in a number of different ways. For example, greatest predicted supplier reaction time 128 may be the top ten suppliers in suppliers 108, with respect to predicted supplier reaction time 124. In another example, greatest predicted supplier reaction time 128 may be suppliers in suppliers 108 that have predicted supplier reaction time 124 that is greater than some threshold level. The threshold level may be a time that it takes to resolve the shortage, such as three days, one week, or some other time. Suppliers having predicted supplier reaction time 124 that is greater than these thresholds would be used to identify ranked suppliers 126 having greatest predicted supplier reaction time 128.

Visualization 142 of ranked suppliers 126 may be displayed on display system 144 for viewing by operator 146. Visualization 142 enables operator 146 to more easily identify and perform operation 148. For example, visualization 142 may be used by operator 146 to perform operation 148, in which production of the group of parts 106 is initiated at an earlier time that reduces a risk of shortage of the group of parts 106.

In another example, controller 206 may output selection 604. Selection 604 may include other current suppliers in suppliers 108 that may be selected to produce the group of parts 106 in place of, or in addition to, the current suppliers in suppliers 108 that produce the group of parts 106. In other illustrative examples, selection 604 may include new suppliers that are not currently in suppliers 108.

The illustration of manufacturing environment 100 and the different components in manufacturing environment 100 depicted in FIGS. 1-6 are not meant to imply physical or architectural limitations to the manner in which an illustrative embodiment may be implemented. Other components in addition to, or in place of, the ones illustrated may be used. Some components may be unnecessary. Also, the blocks are presented to illustrate some functional components. One or more of these blocks may be combined, divided, or combined and divided into different blocks when implemented in an illustrative embodiment.

For example, product 102 may take other forms other than aircraft 104. Product 102 may be selected from a mobile platform, a stationary platform, a land-based structure, an aquatic-based structure, a space-based structure, a surface ship, a tank, a personnel carrier, a train, a spacecraft, a space station, a satellite, a submarine, an automobile, a power plant, a bridge, a dam, a house, a manufacturing facility, a building, an engine, a wing, a fuselage, and other suitable products. In another illustrative example, part manager 110 may also be used in a maintenance environment in which parts are used to perform maintenance on product 102.

As another illustrative example, a group of sources of information may be present in manufacturing environment 100, although not shown in the depicted example. The group of sources of data may provide at least one of historical parts shortage data 116, current parts shortage data 118, historical manufacturing data 136, and other data that may be used within manufacturing environment 100.

These sources may take the form of storage devices or storage systems. Additionally, the sources may include databases on the storage devices, or storage systems that store and organize the data used within manufacturing environment 100.

As yet another illustrative example, manufacturing environment 100 may be in a single location or multiple locations. For example, manufacturing environment 100 may be a single building, or may be distributed among different buildings depending on the particular implementation.

In still another illustrative example, part manager 110 may omit correlator 202 in some implementations. Further, a separate component may be included in part manager 110 to generate visualization 142.

In another illustrative example, controller 206 may generate other outputs in addition to, or in place of, order 600, visualization 142, and selection 604. For example, controller may output a list of suppliers 108 that may benefit from assistance from technical advisors to help identify and resolve issues that may be present in producing parts 106.

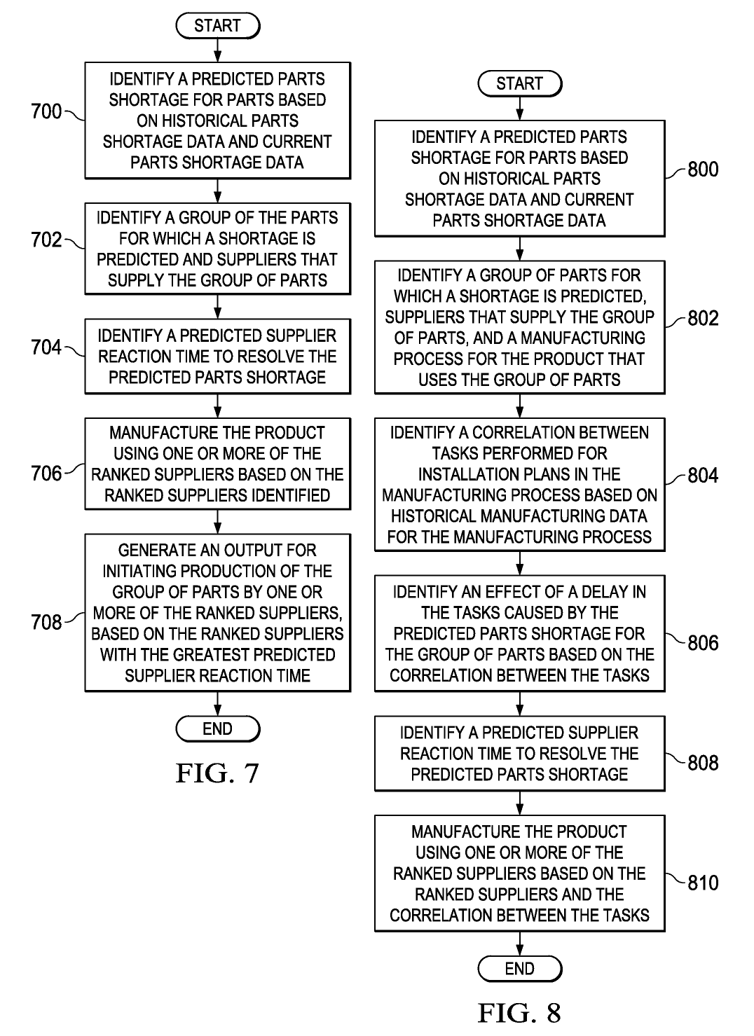

Turning next to FIG. 7, an illustration of a flowchart of a process for manufacturing a product is depicted in accordance with an illustrative embodiment. The process illustrated in FIG. 7 may be implemented in manufacturing environment 100 in FIG. 1. For example, the operations illustrated may be implemented in part manager 110.

The process beings by identifying a predicted parts shortage for parts based on historical parts shortage data and current parts shortage data (operation 700). The process then identifies a group of the parts for which a shortage is predicted and suppliers that supply the group of parts (operation 702). In this illustrative example, the group of parts may be for an insulation plan used to manufacture the product.

The process identifies a predicted supplier reaction time to resolve the predicted parts shortage (operation 704). Then, the process identifies ranked suppliers from the suppliers having a greatest predicted supplier reaction time.

The process manufactures the product using one or more of the ranked suppliers based on the ranked suppliers identified (operation 706). Manufacturing the product may include one or more different operations. For example, operation 706 may comprise initiating production of the group of parts by the one or more of the ranked suppliers at a time that reduces a risk of the shortage for the group of parts.

In yet another example, an operation may comprise identifying a group of new suppliers for the group of parts. In still another illustrative example, the operation may comprise providing assistance to one or more of the ranked suppliers to reduce the predicted supplier reaction time. One or more of these and other operations may be performed in operation 706 as part of manufacturing the product.

The process generates an output for initiating production of the group of parts by one or more of the ranked suppliers, based on the ranked suppliers with the greatest predicted supplier reaction time (operation 708), with the process terminating thereafter. The output may be a visualization of at least one of the ranked suppliers, metrics for the ranked suppliers, or other suitable information for initiating production of the group of parts. The production is initiated in a manner that reduces the risk of a shortage of the group of parts.

The process enables reducing a risk of a shortage for the group of parts. As a result, delays in completing the manufacturing of the product may be reduced.

Turning to FIG. 8, an illustration of a flowchart of a process for managing manufacturing of a product is depicted in accordance with an illustrative embodiment. The process illustrated in FIG. 8 may be implemented in manufacturing environment 100 in FIG. 1. For example, the operations illustrated may be implemented in part manager 110.

The process begins by identifying a predicted parts shortage for parts based on historical parts shortage data and current parts shortage data (operation 800). The process identifies a group of parts for which a shortage is predicted, suppliers that supply the group of parts, and a manufacturing process for the product that uses the group of parts (operation 802).

The process identifies a correlation between tasks performed for installation plans in the manufacturing process, based on historical manufacturing data for the manufacturing process (operation 804). Next, the process identifies an effect of a delay in the tasks caused by the predicted parts shortage for the group of parts, based on the correlation between the tasks (operation 806).

The process also identifies a predicted supplier reaction time to resolve the predicted parts shortage (operation 808). The process identifies ranked suppliers from the suppliers having a greatest predicted supplier reaction time.

The process manufactures the product using one or more of the ranked suppliers, based on the ranked suppliers, and the correlation between the tasks (operation 810), with the process terminating thereafter. The process in FIG. 8 enables reducing a risk of a shortage for the group of parts.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, one of operation 708 or operation 708 may be omitted in some implementations. As another example, instead of terminating after operation 708, the process may return to operation 702 any number of times to identify a shortage for other groups of parts for other installation plans.

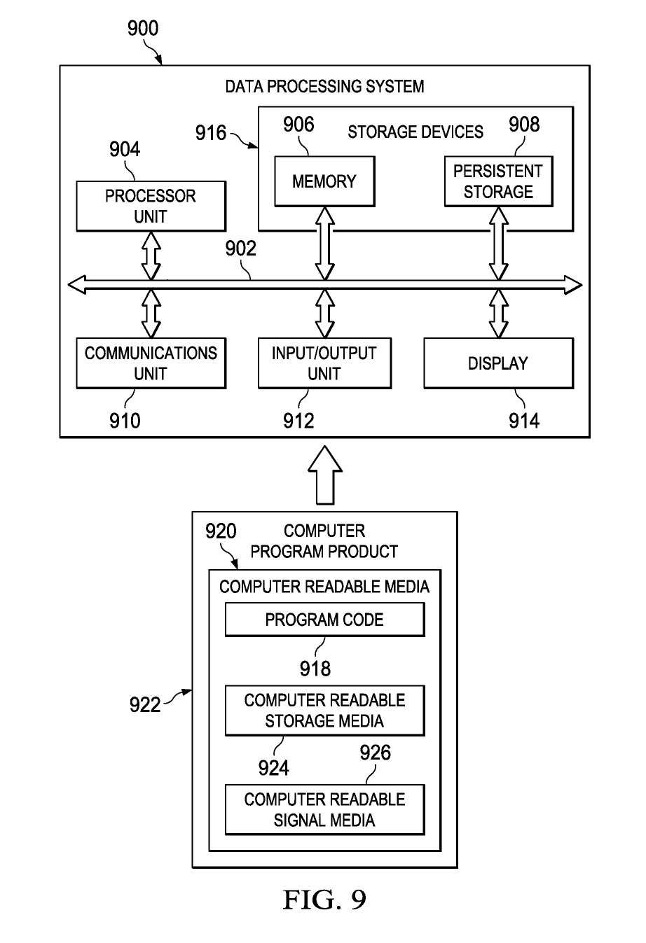

Turning now to FIG. 9, an illustration of a block diagram of a data processing system is depicted in accordance with an illustrative embodiment. Data processing system 900 may be used to implement one or more data processing systems in computer system 112 of FIG. 1. In this illustrative example, data processing system 900 includes communications framework 902, which provides communications between processor unit 904, memory 906, persistent storage 908, communications unit 910, input/output (I/O) unit 912, and display 914. In this example, communications framework 902 may take the form of a bus system.

Processor unit 904 serves to execute instructions for software that may be loaded into memory 906. Processor unit 904 may be a number of processors, a multi-processor core, or some other type of processor, depending on the particular implementation.

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer readable storage devices in these illustrative examples. Memory 906, in these examples, may be, for example, a random access memory or any other suitable volatile or non-volatile storage device. Persistent storage 908 may take various forms, depending on the particular implementation.

For example, persistent storage 908 may contain one or more components or devices. For example, persistent storage 908 may be a hard drive, a solid state hard drive, a flash memory, a rewritable optical disk, a rewritable magnetic tape, or some combination of the above. The media used by persistent storage 908 also may be removable. For example, a removable hard drive may be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that may be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs may be located in storage devices 916, which are in communication with processor unit 904 through communications framework 902. The processes of the different embodiments may be performed by processor unit 904 using computer-implemented instructions, which may be located in a memory, such as memory 906.

These instructions are referred to as program code, computer usable program code, or computer readable program code that may be read and executed by a processor in processor unit 904. The program code in the different embodiments may be embodied on different physical or computer readable storage media, such as memory 906 or persistent storage 908.

Program code 918 is located in a functional form on computer readable media 920 that is selectively removable and may be loaded onto or transferred to data processing system 900 for execution by processor unit 904. Program code 918 and computer readable media 920 form computer program product 922 in these illustrative examples. In one example, computer readable media 920 may be computer readable storage media 924 or computer readable signal media 926. In these illustrative examples, computer readable storage media 924 is a physical or tangible storage device used to store program code 918, rather than a medium that propagates or transmits program code 918.

Alternatively, program code 918 may be transferred to data processing system 900 using computer readable signal media 926. Computer readable signal media 926 may be, for example, a propagated data signal containing program code 918. For example, computer readable signal media 926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 900 are not meant to provide architectural limitations to the manner in which different embodiments may be implemented. The different illustrative embodiments may be implemented in a data processing system including components in addition to or in place of those illustrated for data processing system 900. Other components shown in FIG. 9 can be varied from the illustrative examples shown. The different embodiments may be implemented using any hardware device or system capable of running program code 918.

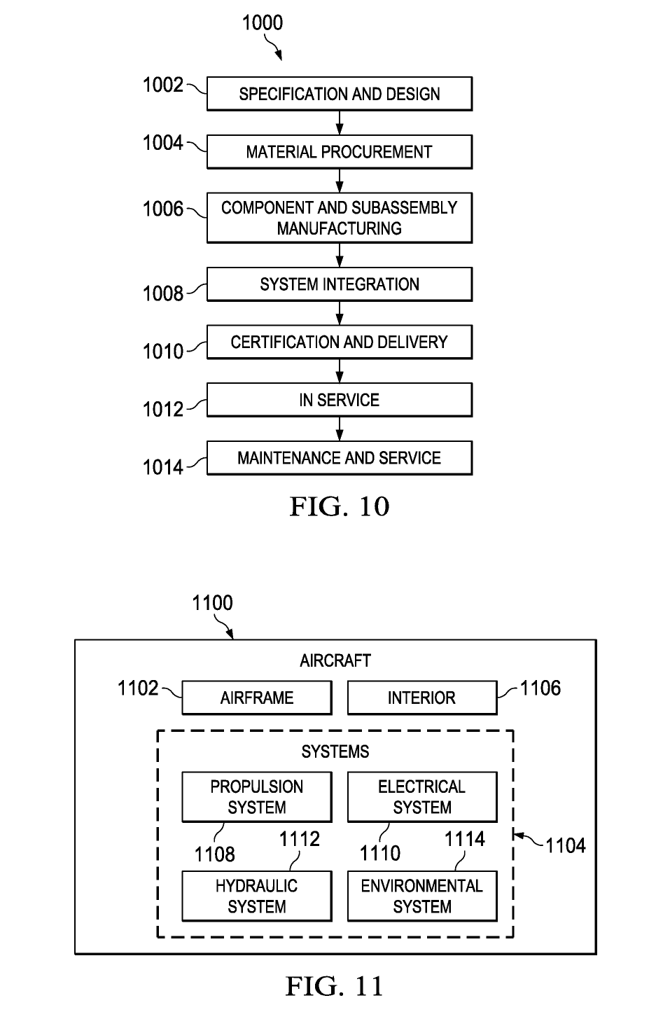

Illustrative examples in the disclosure may be described in the context of aircraft manufacturing and service method 1000 as shown in FIG. 10 and aircraft 1100 as shown in FIG. 11. Turning first to FIG. 10, an illustration of a block diagram of an aircraft manufacturing and service method is depicted in accordance with an illustrative embodiment. During pre-production, aircraft manufacturing and service method 1000 may include specification and design 1002 of aircraft 1100 in FIG. 11 and material procurement 1004.

During production, component and subassembly manufacturing 1006 and system integration 1008 of aircraft 1100 in FIG. 11 takes place. Part manager 110 of FIG. 1 may be used to reduce shortages in parts that may cause delays in these manufacturing stages to manage manufacturing of aircraft 1100. Thereafter, aircraft 1100 in FIG. 11 may go through certification and delivery 1010 in order to be placed in service 1012. While in service 1012 by a customer, aircraft 1100 in FIG. 11 is scheduled for routine maintenance and service 1014, which may include modification, reconfiguration, refurbishment, and other maintenance or service. Part manager 110 may be used to reduce shortages in parts that may cause delays in maintenance and service 1014 for parts needed for maintenance and service 1014 of aircraft 1100.

Each of the processes of aircraft manufacturing and service method 1000 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of a block diagram of an aircraft is depicted in which an illustrative embodiment may be implemented. In this example, aircraft 1100 is produced by aircraft manufacturing and service method 1000 in FIG. 10 and may include airframe 1102 with plurality of systems 1104 and interior 1106. Examples of systems 1104 include one or more of propulsion system 1108, electrical system 1110, hydraulic system 1112, and environmental system 1114. Any number of other systems may be included. Although an aerospace example is shown, different illustrative embodiments may be applied to other industries, such as the automotive industry, the ship building industry, the spacecraft industry, or some other suitable industry.

Apparatuses and methods embodied herein may be employed during at least one of the stages of aircraft manufacturing and service method 1000 in FIG. 10. The use of a number of the different illustrative embodiments may substantially expedite the assembly of aircraft 1100, reduce the cost of aircraft 1100, or both expedite the assembly of aircraft 1100 and reduce the cost of aircraft 1100.

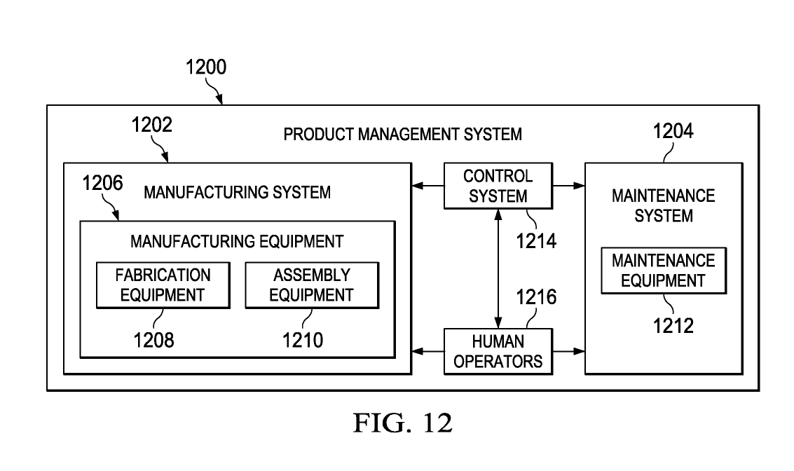

Turning now to FIG. 12, an illustration of a block diagram of a product management system is depicted in accordance with an illustrative embodiment. Product management system 1200 is a physical hardware system. In this illustrative example, product management system 1200 may include at least one of manufacturing system 1202 or maintenance system 1204.

Manufacturing system 1202 is configured to manufacture products, such as aircraft 1100 in FIG. 11. As depicted, manufacturing system 1202 includes manufacturing equipment 1206. Manufacturing equipment 1206 includes at least one of fabrication equipment 1208 or assembly equipment 1210.

Fabrication equipment 1208 is equipment that may be used to fabricate components for parts used to form aircraft 1100. For example, fabrication equipment 1208 may include machines and tools. These machines and tools may be at least one of a drill, a hydraulic press, a furnace, a mold, a composite tape laying machine, a vacuum system, a lathe, or other suitable types of equipment. Fabrication equipment 1208 may be used to fabricate at least one of metal parts, composite parts, semiconductors, circuits, fasteners, ribs, skin panels, spars, antennas, or other suitable types of parts.

Assembly equipment 1210 is equipment used to assemble parts to form aircraft 1100. In particular, assembly equipment 1210 may be used to assemble components and parts to form aircraft 1100. Assembly equipment 1210 also may include machines and tools. These machines and tools may be at least one of a robotic arm, a crawler, a faster installation system, a rail-based drilling system, a robot, or other suitable types of equipment. Assembly equipment 1210 may be used to assemble parts such as seats, horizontal stabilizers, wings, engines, engine housings, landing gear systems, and other parts for aircraft 1100.

In this illustrative example, maintenance system 1204 includes maintenance equipment 1212. Maintenance equipment 1212 may include any equipment needed to perform maintenance on aircraft 1100. Maintenance equipment 1212 may include tools for performing different operations on parts on aircraft 1100. These operations may include at least one of disassembling parts, refurbishing parts, inspecting parts, reworking parts, manufacturing placement parts, or other operations for performing maintenance on aircraft 1100. These operations may be for routine maintenance, inspections, upgrades, refurbishment, or other types of maintenance operations.

In the illustrative example, maintenance equipment 1212 may include ultrasonic inspection devices, x-ray imaging systems, vision systems, drills, crawlers, and other suitable device. In some cases, maintenance equipment 1212 may include fabrication equipment 1208, assembly equipment 1210, or both to produce and assemble parts that may be needed for maintenance.

Product management system 1200 also includes control system 1214. Control system 1214 is a hardware system and may also include software or other types of components. Control system 1214 is configured to control the operation of at least one of manufacturing system 1202 or maintenance system 1204. In particular, control system 1214 may control the operation of at least one of fabrication equipment 1208, assembly equipment 1210, or maintenance equipment 1212.

The hardware in control system 1214 may be using hardware that may include computers, circuits, networks, and other types of equipment. The control may take the form of direct control of manufacturing equipment 1206. For example, robots, computer-controlled machines, and other equipment may be controlled by control system 1214. In other illustrative examples, control system 1214 may manage operations performed by human operators 1216 in manufacturing or performing maintenance on aircraft 1100. For example, control system 1214 may assign tasks, provide instructions, display models, or perform other operations to manage operations performed by human operators 1216.

In these illustrative examples, part manager 110 from FIG. 1 may be implemented in control system 1214 to manage at least one of the manufacturing or maintenance of aircraft 1100 in FIG. 11. In particular, part manager 110 may be used to manage ordering of parts from suppliers. Further, the predicted part shortages identified by part manager 110 may be used to manage the manufacturing process control in control system 1214.

Further, parts manager 110 may be used by control system 1214 to manage maintenance processes performed using maintenance system 1204. For example, scheduling of maintenance for products using maintenance system 1204 may be made based on predicted parts shortages identified by using part manager 110. Further, the ordering of parts using maintenance system 1204 may be initiated in a manner to reduce part shortages for performing maintenance processes.

In the different illustrative examples, human operators 1216 may operate or interact with at least one of manufacturing equipment 1206, maintenance equipment 1212, or control system 1214. This interaction may be performed to manufacture aircraft 1100.

Of course, product management system 1200 may be configured to manage other products other than aircraft 1100. Although aircraft management system 1200 has been described with respect to manufacturing in the aerospace industry, aircraft management system 1200 may be configured to manage products for other industries. For example, aircraft management system 1200 may be configured to manufacture products for the automotive industry, as well as any other suitable industries.

Thus, the illustrative embodiments provide a method and apparatus for managing a product. The management may include managing parts used in at least one of manufacturing or maintaining a product such as an aircraft. The illustrative example provides a method and apparatus that overcome a technical problem with reducing parts shortages caused by suppliers currently supplying parts for manufacturing a product such as an aircraft. The technical solution in the illustrative example provides a technical effect of enabling a reduction of delays in managing a product. For example, delays in manufacturing a product, delays in performing maintenance on a product, or some combination thereof may be reduced.

The description of the different illustrative embodiments has been presented for purposes of illustration and description, and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for managing manufacturing of a product, the method comprising:
identifying, by a computer system, a predicted parts shortage for parts based on historical parts shortage data and current parts shortage data;
identifying, by the computer system, a group of parts for which a shortage is predicted and suppliers that supply the group of parts;
identifying, by the computer system, a predicted supplier reaction time to resolve the predicted parts shortage;
identifying, by the computer system, ranked suppliers from the suppliers having a greatest predicted supplier reaction time; and
manufacturing the product using one or more of the ranked suppliers based on the ranked suppliers identified, thereby enabling reducing a risk of the shortage for the group of parts.

2. The method of claim 1 further comprising:
generating an output for initiating production of the group of parts by one or more of the ranked suppliers based on the ranked suppliers with the greatest predicted supplier reaction time.

3. The method of claim 1, wherein manufacturing the product using the one or more of the ranked suppliers based on the ranked suppliers comprises:
initiating production of the group of parts by the one or more of the ranked suppliers at a time that reduces the risk of the shortage for the group of parts.

4. The method of claim 1, wherein manufacturing the product using the one or more of the ranked suppliers based on the ranked suppliers identified, thereby enabling reducing the risk of the shortage for the group of parts comprises:
identifying a group of new suppliers for the group of parts.

5. The method of claim 1, wherein manufacturing the product using the one or more of the ranked suppliers based on the ranked suppliers identified, thereby enabling reducing the risk of the shortage for the group of parts comprises:
providing assistance to the one or more of the ranked suppliers to reduce the predicted supplier reaction time.

6. The method of claim 1 further comprising:
identifying, by the computer system, a correlation between tasks performed for installation plans in a manufacturing process for the product that uses the group of parts based on historical manufacturing data for the manufacturing process;
identifying, by the computer system, an effect of a delay in the tasks caused by the predicted parts shortage for the group of parts based on the correlation between the tasks; and
wherein managing manufacturing of the product based on a group of ranked suppliers and the correlation between the tasks comprises:
managing manufacturing of the product based on the one or more of the ranked suppliers, the correlation between the tasks, and the effect of the delay in the tasks, enabling reducing the risk of the shortage for the group of parts.

7. The method of claim 6, wherein the effect is selected from at least one of an impact on manufacturing jobs, an impact on suppliers, a delay in manufacturing the product, or an impact on delivery of the product to a customer.

8. The method of claim 6 further comprising:
identifying supplier performance; and
wherein managing manufacturing of the product based on the group of ranked suppliers, the correlation between the tasks, and the effect of the delay in the tasks comprises:
managing manufacturing of the product based on the group of ranked suppliers, the correlation between the tasks, the effect of the delay in the tasks, and the supplier performance.

9. The method of claim 1 further comprising:
generating an output of the ranked suppliers with the greatest predicted supplier reaction time; and
initiating production of the group of parts by the one or more of the ranked suppliers based on ranked suppliers with the greatest predicted supplier reaction time.

10. The method of claim 1, wherein the product is selected from a group comprising a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a house, a manufacturing facility, a building, an engine, a wing, a fuselage, and a door.

11. A method for managing manufacturing of a product, the method comprising:
identifying, by a computer system, a predicted parts shortage for parts based on historical parts shortage data and current parts shortage data;
identifying, by the computer system, a group of parts for which a shortage is predicted, suppliers that supply the group of parts, and a manufacturing process for the product that uses the group of parts;
identifying, by the computer system, a correlation between tasks performed for installation plans in the manufacturing process based on historical manufacturing data for the manufacturing process;
identifying, by the computer system, an effect of a delay in the tasks caused by the predicted parts shortage for the group of parts based on the correlation between the tasks;
identifying, by the computer system, a predicted supplier reaction time to resolve the predicted parts shortage;
identifying, by the computer system, ranked suppliers from the suppliers having a greatest predicted supplier reaction time; and
manufacturing of the product using one or more of the ranked suppliers based on the ranked suppliers and the correlation between the tasks, enabling reducing a risk of the shortage for the group of parts.

12. The method of claim 11 further comprising:
generating an output for initiating production of the group of parts by the one or more of the ranked suppliers based on the ranked suppliers with the greatest predicted supplier reaction time.

13. The method of claim 11, wherein manufacturing of the product using the one or more of the ranked suppliers based on the ranked suppliers and the correlation between the tasks, enabling reducing the risk of the shortage for the group of parts comprises:
initiating production of the group of parts by the one or more of the ranked suppliers at a time that reduces the risk of the shortage for the group of parts based on the ranked suppliers and the correlation between the tasks.

14. The method of claim 11, wherein the effect is selected from at least one of an impact on manufacturing jobs, an impact on suppliers, a delay in manufacturing the product, or an impact on delivery of the product to a customer.

15. The method of claim 11 further comprising:
generating an output of the ranked suppliers with the greatest predicted supplier reaction time; and
initiating production of the group of parts by the one or more of the ranked suppliers based on ranked suppliers with the greatest predicted supplier reaction time.

16. The method of claim 11, wherein the product is selected from a group comprising a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a house, a manufacturing facility, a building, an engine, a wing, a fuselage, and a door.

17. A product management system comprising:
a part manager that identifies a predicted parts shortage for parts for a product based on historical parts shortage data and current parts shortage data; identifies a group of parts for which a shortage is predicted and a group of suppliers that supply the group of parts; identifies a predicted supplier reaction time to resolve the predicted parts shortage; identifies ranked suppliers from the suppliers having a greatest predicted supplier reaction time; and controls manufacturing of the product based on the ranked suppliers, enabling reducing a risk of a shortage for the group of parts.

18. The product management system of claim 17, wherein parts are used in a product management process for manufacturing the product and further comprises:
a manufacturing system.

19. The product management system of claim 17, wherein the parts are used in a product management process for maintaining the product and further comprises:
a maintenance system.

20. The product management system of claim 17, wherein the part manager generates an output for initiating production of the group of parts by one or more of the ranked suppliers based on the ranked suppliers identified with the greatest predicted supplier reaction time.

21. The product management system of claim 17, wherein the part manager initiates production of the group of parts with one or more of the ranked suppliers at a time that reduces the risk of the shortage for the group of parts.

22. The product management system of claim 17, wherein in managing manufacturing of the product based on the group of ranked suppliers, the part manager identifies a group of new suppliers for the group of parts.

23. The product management system of claim 17, wherein in managing manufacturing of the product based on the group of ranked suppliers, the part manager schedules providing assistance to one or more of the suppliers to reduce the predicted supplier reaction time.

24. The product management system of claim 17, wherein the part manager identifies a correlation between tasks performed for installation plans in a manufacturing process based on historical manufacturing data for the manufacturing process; identifies an effect of a delay in the tasks caused by the predicted parts shortage for the group of parts based on the correlation between the tasks; and wherein in managing manufacturing of the product based on the group of ranked suppliers and the correlation between the tasks, the part manager manages manufacturing of the product based on the ranked suppliers, the correlation between the tasks, and the effect of the delay in the tasks, enabling reducing the risk of the shortage for the group of parts, wherein the effect is selected from at least one of an impact on manufacturing jobs, an impact on suppliers, a delay in manufacturing the product, or an impact on delivery of the product to a customer.

25. The product management system of claim 17, wherein the part manager generates an output of ranked suppliers with the greatest predicted supplier reaction time; and initiates production by one or more of the ranked suppliers based on the ranked suppliers with the greatest predicted supplier reaction time.

26. The product management system of claim 17, wherein the product is selected from a group comprising a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a house, a manufacturing facility, a building, an engine, a wing, a fuselage, and a door.
